(19) United States
(12) Patent Application Publication
(10) Pub. No.: US 2007/0050332 A1
(43) Pub. Date: Mar. 1, 2007

(54) Method and apparatus for providing a comparative product information of related products

(76) Inventors: Christopher G. Grenzberg, Allentown, PA (US); Gerhard B. Grenzberg, Clarks Green, PA (US)

Correspondence Address: DUANE MORRIS LLP, Suite 700, 1667 K Street, N.W., Washington, DC, 20006, US

(21) Appl. No.: 11/211,710

(22) Filed: Aug. 26, 2005

(51) Int. Cl. G06F 17/30

(52) U.S. Cl. 707/3

(57) ABSTRACT

The disclosure relates to a method and a system for conducting local or global searches for industrial equipment information and providing search reports that not only identifies the corresponding products but also provide a meaningful comparison among the identified products. In an embodiment, the system receives a search inquiry from a subscriber or purchaser of the services for identifying the desired product. The desired product can be identified through its attributes. The system then searches a database to identify all products matching one or more of the identified attributes and compiles a search report. Thus, the search report may identify products from different vendors, with all products defined by their common attributes, such as product specification. Thereafter, the system converts all similar attributes to have the same quantifiable units. The search result is then presented to the subscriber.

### BACKGROUND

The instant disclosure generally relates to a method and apparatus for providing comparative product information for related products. More specifically, the disclosure relates to a system for conducting local or global search for equipment information and providing search report that not only identifies the corresponding products but also provides a meaningful comparison among the identified products.

Engineers, Production and Maintenance Supervisors as well as Purchasing agents for manufacturing and industrial companies spend a significant portion of their working hours researching and identifying the desired industrial or commercial products. The products may include industrial equipments, hardware, software, electronics or even commercial services and extended warranties. The conventional search and identification process typically involves contacting various vendors, obtaining verbal and written product information, reviewing available product catalogues, reviewing online catalogues and making a purchasing recommendation or decision based thereon.

The conventional approach is inefficient, incomplete and inaccurate. The conventional approach is inefficient because it requires spending countless hours identifying manufacturers and service providers. The inefficiency is further compounded should the interested party not be familiar with the area of technology, product, or the underlying service. Another source of inefficiency is the lack of viable information at the immediate disposal of the purchasing agent. Product information is typically presented by manufacturers in product catalogues. Assuming the online catalogues are available, still the online resources are typically provided on a company-by-company basis. Thus, an interested buyer searching for product information must visit different websites and study each company's catalogue independently. Even then the search result may be incomplete for failure to identify all providers of the desired products.

Finally, assuming that the product information is available online or through written product catalogues, providing a meaningful comparison is still difficult since each company's product information may be provided using different quantification units. For example, when purchasing industrial mixing equipment a first company's product catalogue may define its product in metric units while its competitor may describe its product in English units. In addition, each company may provide only a limited number of attributes for their product rendering a qualitative comparison impossible.

### SUMMARY

In one embodiment, the disclosure relates to a processor programmed with a plurality of executable instructions for facilitating commercial product transactions for a subscriber, the instructions may include receiving a search request from the subscriber, the search request corresponding to a desired product and defined by a plurality of search parameters, each search parameter defined by at least one output unit; querying a data repository using said plurality of search parameters; receiving a search result from said data repository, the search result identifying at least one product, the product defined by a plurality of attributes; converting at least one of the plurality of attributes to conform with at least one of the plurality of desired output units; and providing an output of the search result with at least one converted attribute.

In another embodiment, the disclosure relates to a processor programmed with executable instructions for facilitating online commercial transactions of products. The instruction may includes receiving a search request from the subscriber, the search request corresponding to a desired product and defined by a plurality of search parameters, each search parameter defined by at least one output unit; querying a data repository using said plurality of search parameters; receiving a search result from said data repository, the search result identifying at least one product, the product defined by a plurality of attributes; converting at least one of the plurality of attributes to conform with at least one of the plurality of desired output units; and providing an output of the search result with at least one converted attribute.

Another embodiment of the disclosure relates to a method for providing comparative product information of related products by receiving a search criteria defining a product category, the search criteria identifying one or more attributes of the product; searching a primary database for all products matching the attribute of the product to form a search result; ranking the products identified in the search results in an order; identifying one or more measurement units corresponding to each attribute; selecting a common measurement unit for each attribute; and converting the measurement unit for each attribute to correspond to the common measurement unit to thereby provide comparative product information.

In still another embodiment, the disclosure relates to a system for implementing a product search in response to a subscriber inquiry, the system comprising a memory for storing at least one database, the database including product-specific information for a plurality of products; and a processor in communication with the memory and the subscriber, the processor configured to receive a search request from the subscriber, the search request corresponding to a desired product and defined by a plurality of search parameters, each search parameter defined by at least one output unit; the processor is configured to query a data repository using said plurality of search parameters; receive a search result from said data repository, the search result identifying at least one product, the product defined by a plurality of attributes; convert at least one of the plurality of attributes to conform with at least one of the plurality of desired output units; and provide an output of the search result with at least one converted attribute. This exemplary embodiment provides information of the basic models as the search result. This can be expanded by adding selected options to the search parameters to receive a search result more specific to the requirements.

### BRIEF DESCRIPTION OF THE DRAWINGS

FIG. 1 is a flow diagram describing an exemplary method for providing a comparative product information for related products according to one embodiment of the disclosure;

FIG. 2 is a flow diagram describing a sub-routine shown in FIG. 1;

FIG. 3 is an exemplary representation of a search report after the conversion; and

FIG. 4 is a schematic diagram of an apparatus according to an embodiment of the disclosure.

### DETAILED DESCRIPTION

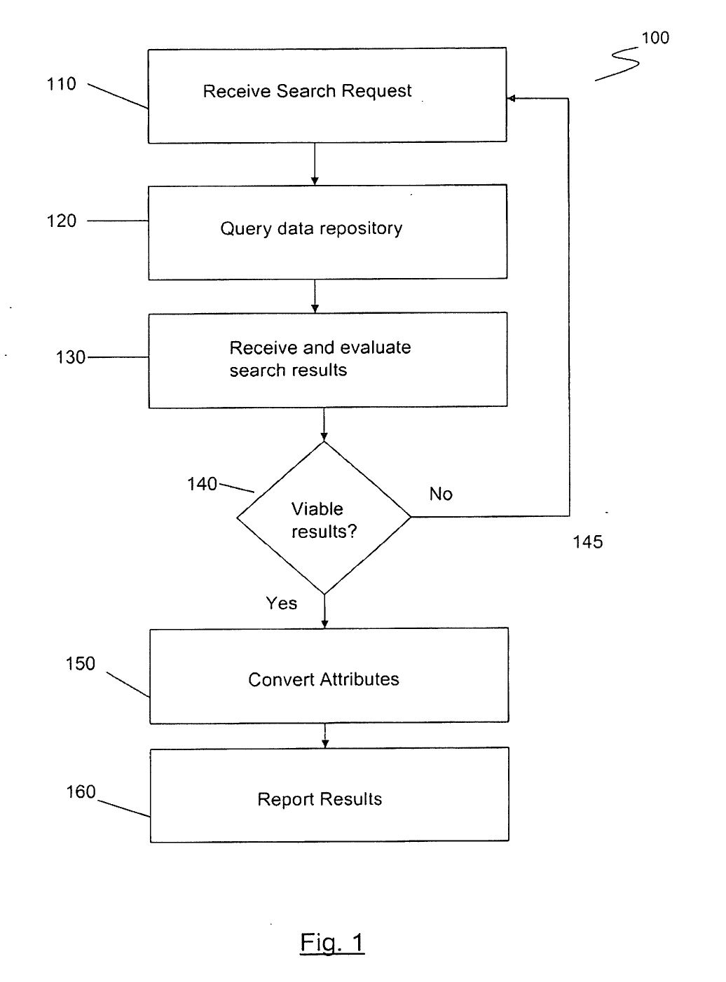

FIG. 1 is a flow diagram describing an exemplary method for providing comparative product information for related products according to one embodiment of the disclosure. The flow diagram 100 shown in FIG. 1 can be the basis for a software algorithm residing on a memory and instructing one or more processors to conduct specific steps. Referring to FIG. 1, in step 110 the algorithm receives instructions concerning the scope of the search. The search may concern any industrial or commercial product, equipment or services (interchangeably, products). The search request may include any conventional format. For example, the search request may include identifying a category of products along with specific desired attributes. The search page may also provide educational material for subscriber's review. By way of example, the subscriber may be educated as to various product categories and the state-of-the art in each category.

In one embodiment, the step of receiving a search request includes providing a predefined graphic user interface to ease interaction between the subscriber and the algorithm. In another embodiment, the subscriber identifies the desired product by answering various questions posed by algorithm 100. In still another embodiment, the step of receiving a search request from the subscriber includes a Boolean-type search based on specific keywords identified by the subscriber. In addition to identifying the desired product by type and category, the subscriber can define the product by its attributes such as product specifications, costs and tolerances in English or metric units, such as pounds, kilograms, inches, meters, Dollars, Euros, etc. Further, the product attribute may be ranked in an order of importance. Finally, the subscriber may request that the quantifiable units for each product be identified through the search to conform to a desired unit defined by the subscriber.

For example, a subscriber may identify the desired product as an industrial microscope. The subscriber may further define the desired product by selecting the desired attributes to include electronic microscope, magnification limits (e.g., ×20,000) and ability to electronically communicate with conventional software. The subscriber may further rank the attributes in an ascending/descending order of importance. In the vernacular of this example, the search criteria define the desired product as an electronic microscope, primarily having 20,000 magnification and secondarily being compatible with conventional software. The selection of optional attributes can further refine the search process.

In step 120, algorithm 100 conducts a search of one or more data repositories. The data repository may include online databases, product catalogues or known vendor websites. In one embodiment of the disclosure the data repository is a pre-defined database containing global product information. The database may be made available through online subscription. Alternatively, the database can be purchased on magnetic disc, optical disc, or other electronic or electro-optical recording mediums. The database may include product specifications, product attribute, product reviews, pricing information or any other pertinent information.

The search step 120 may include searching the database to identify products matching the general category identified by the subscriber. The search step may further include narrowing the search criteria by eliminating products that fail to match one or more attributes identified by the subscriber. The search may also include ranking of the products in an order that conforms to the subscriber's request. For example, a number of electronic microscopes can be ranked in an ascending order corresponding to each product's conformance with the attributes defined by the subscriber. Should the subscriber also define optional attributes, the search result can be further organized to present the most on-point products first.

Once the matching products have been identified, algorithm 100 must test the validity of the search result. This step is schematically shown in step 140. While this step maybe optional, its implementation can prevent erroneous or invalid search reports. To test whether the search result is valid, the system can use secondary considerations defined by the programmer or by the subscriber. The secondary considerations may include, for example, factors such as contacting equipment manufacturer to ensure availability of the product. Conversely, if the search result has failed to identify any product then step 140 can revert the program back to step 110 and request clarification from the subscriber or redefine the search criteria and to increase the probability of matching products. This step is schematically shown as step 145 in FIG. 1.

In step 150 the attributes of the products identified in the search result are converted to a common unit. Industrial and commercial products have many attributes. These attributes are measured and quantified with well-known units. For example, industrial cranes have the attributes of reach and lift. Reach is the effective length of cane's arm and lift the amount of weight and/or height that the crane can safely elevate. The attribute of reach or height distance may be quantified with metric and English units, i.e., feet (ft.) or meter (m) while the attribute of weight may be quantified with units of pounds (lb.) or kilogram (kg.). A comprehensive comparison of industrial cranes made by different suppliers requires converting the different products to one unit. Thus, a Japanese product defined by metric units can be appropriately compared against an American manufacturer's product having English units. Step 150 of the algorithm 100 implements such conversions. Step 150 may also include converting the quantifiable units of each product to units defined by the subscriber in step 110.

In step 160, the search results are reported to the subscriber. The report may comprise an electronic communication or a written report. Various formats can be used to report the data to subscribers without departing from the principles disclosed herein.

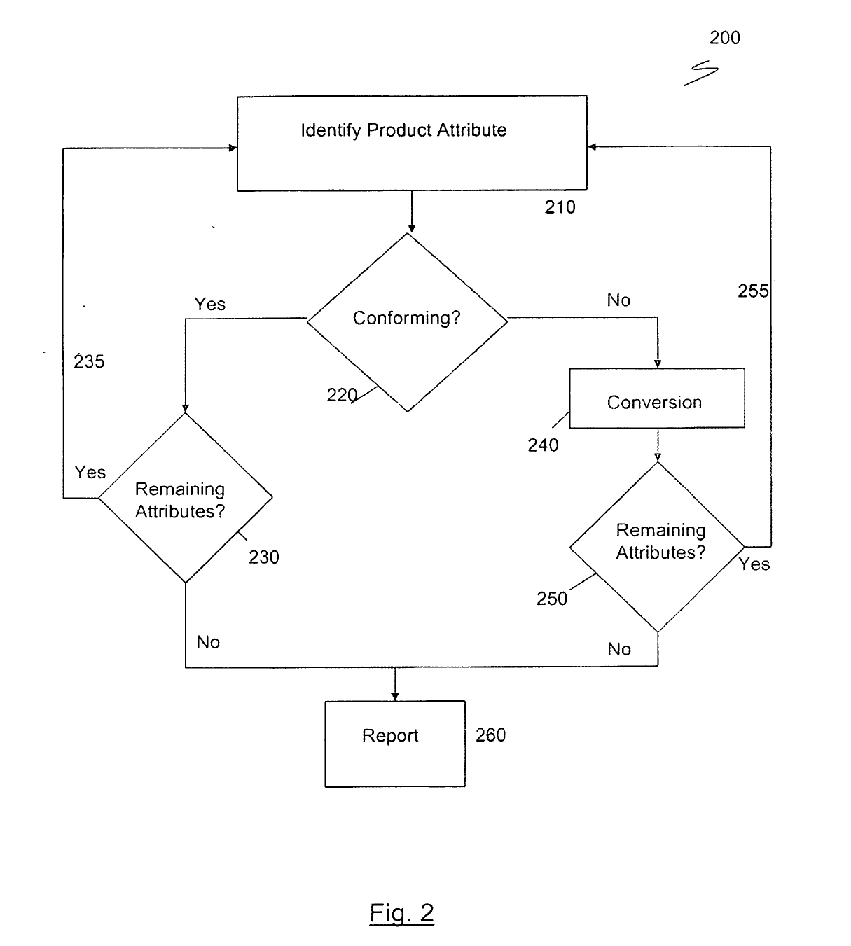

FIG. 2 is a flow diagram describing a sub-routine shown in FIG. 1. Specifically, algorithm 200 describes an exemplary algorithm for converting a product attribute as described in step 150 of FIG. 1. In step 210, a product is identified as matching the search string and the product attributes are identified. As discussed, the attributes include units that quantifiably define the product. In step 220, the algorithm determines whether one or more of said attributes conform to a predefined unit. The predefined unit may be addressed by the subscriber or defined by the algorithm itself. If the unit of an exemplary attribute conforms to the predefined unit, then no additional conversion is needed and the process proceeds to step 230. In step 230 the algorithm determines whether there are remaining attributes, which may require consideration. If such attributes are identified, then the process is repeated (see step 235). If no such attribute is identified, then the process ends and the results may be reported as in step 260.

On the other hand, if an exemplary product attribute is quantified by a unit not in conformance with the desired unit, then the mathematical operations are implemented in step 240 to convert the product attribute to the desired unit. At the conclusion of step 240, the algorithm determines whether the product has a remaining attribute for conversion, and if so, through step 255, the process is repeated. In the event that there are no remaining attributes, the algorithm can be concluded at step 260 by reporting the conversion results. That is, the product is now defined in terms of attributes defined by the desired units.

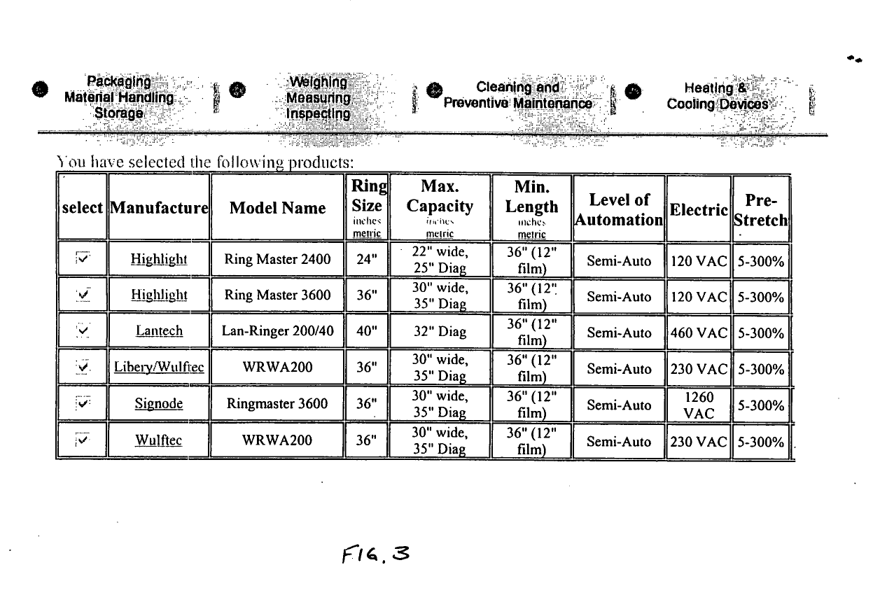

FIG. 3 is an exemplary search report. In FIG. 3 the subscriber's search was directed an item of packaging equipment, namely, a horizontal stretch wrap machine. A preliminary searches of all equipment matching the search result are provided to the subscriber, as shown in FIG. 3. In the exemplary representation of FIG. 3, the subscriber can optionally select one or more product of interest and retrieve further information thereon. It can be seen from FIG. 3 that all product attributes such as ring size, maximum capacity and minimum length for all equipment is reported in inches. Thus, the exemplary search report of FIG. 3 shows the search results after a conversion has been implemented. For example, at the top of the dimension columns, mm. and in. are shown. By clicking on the mm, all dimensions will change to metric and will be shown in millimeters.

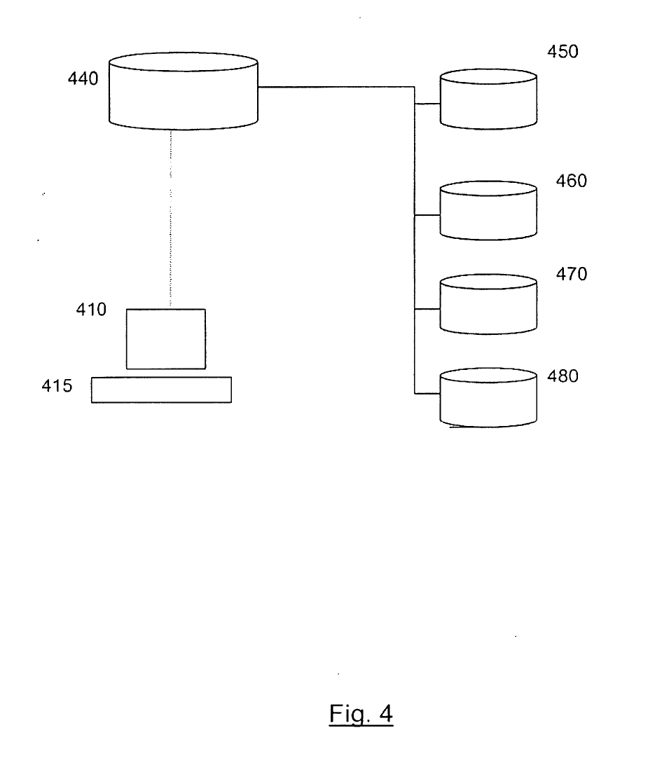

FIG. 4 is a schematic diagram of an exemplary apparatus according to one embodiment of the disclosure. In FIG. 4 computer 410 communicates with the subscriber through keyboard 415. While FIG. 4 shows a conventional computer, the disclosure should not be limited thereto and shall include other means for communicating with a subscriber and communicating data. Computer 410 comprises one or more processors programmed with instructions to conduct a product search according to the methods disclosed herein. Upon identifying the search parameters, the processors query data repository 440 for product information. In the exemplary embodiment of FIG. 4, the repository 440 communicates with databases 450 through 480, which may contain additional product information. In another embodiment, repository 440 contains cumulative data from all of the databases. Databases 450 through 480 can represent product catalogues, the Internet and any other data source directed that might contain information of interest to the subscriber. Data repository 440 may be in the form of a web address or an electronic storage media. In the latter case, the subscriber can be offered a to purchase a copy of the compiled information as a download, or in a CD or DVD. The subscriber may further receive regular updates to the information.

In another embodiment, the subscriber is advised of the optional features that relate to a selected product. For example, the subscriber searching for packaging equipment may be advised that certain products may be purchased with optional features that are not standard to that equipment. The optional information may also include financing or other financial incentives that are offered by a manufacturer, the forecasted maintenance cost and the expected salvage value for various products.

While the disclosure has been discussed in relation to specific embodiments, the inventive principles disclosed herein are not limited to these embodiments and include any permutation, modification or deviation from these embodiments.

1. A processor programmed with executable instructions for facilitating online commercial transactions of products, the instructions comprising:
receiving a search request from the subscriber, the search request corresponding to a desired product defined by a plurality of search parameters, each search parameter quantified by at least one output unit;
querying a data repository using said plurality of search parameters;
receiving a search result from said data repository, the search result identifying at least one product having an attribute;
converting the product attribute to conform with at least one of the plurality of desired output units; and
providing an output of the search result with at least one converted attribute.

2. The process of claim 1, wherein the search request further comprises an input from a web site.

3. The process of claim 1, wherein the search request is a request for a Boolean search.

4. The process of claim 1, wherein the search request further comprises an application-specific search string.

5. The process of claim 1, wherein the subscriber is a web application.

6. The process of claim 1, wherein the search parameters define the product.

7. The process of claim 1, wherein the product is selected from the group consisting of industrial equipment, commercial products, banking services, software and electronics.

8. The process of claim 1, wherein the data repository further comprises a database.

9. The process of claim 8, wherein the database further comprises an SQL Server database.

10. The process of claim 8, wherein the database further comprises an Oracle database®.

11. The process of claim 1, wherein the data repository further comprises an internet search engine.

12. The process of claim 1, wherein the search result further comprises a plurality of products wherein at least one attribute of each product corresponds to one of the plurality of the search parameters.

13. The process of claim 1, wherein the search result further comprises a plurality of products wherein each product corresponds to the plurality of the search parameters.

14. The process of claim 1, wherein the output of the search results to the subscriber further comprises a web page.

15. A method for providing comparative product information of related products, comprising:
receiving search criteria defining a product category, the search criteria identifying one or more attributes of the product;
searching a primary database for all products matching at least one attribute of the product to form a search result;
ranking the products identified in the search results in an order;
identifying one or more measurement units corresponding to each attribute;
selecting a common measurement unit for each attribute; and
converting the measurement unit for each attribute to correspond to the common measurement unit to thereby provide comparative product information.

16. The method of claim 15, wherein the search criteria further comprises product information.

17. The method of claim 15, further comprising searching a secondary database and compiling a search result incorporating the search from the primary and the secondary database.

18. The method of claim 15, further comprising searching a secondary database and compiling a search result incorporating the search from the primary and the secondary database; wherein the primary database and the secondary database are co-located.

19. The method of claim 15, further comprising searching a secondary database and compiling a search result incorporating the search from the primary and the secondary database; wherein the primary database defines an online search and the secondary database defines a catalog stored in a memory.

20. The method of claim 15, wherein the step of ranking the products identified in the search results further comprises ranking the products in an ascending order corresponding to the number of matching attributes of each product with the search criteria.

21. The method of claim 15, wherein the common measurement unit is defined in the search criteria.

22. The method of claim 15, wherein the common measurement unit is selected in relation to previous searches.

23. The method of claim 15, wherein the step of converting the measurement unit for each attribute further comprises calculating a conversion factor.

24. The method of claim 15, further comprising communicating the search report.

25. The method of claim 15, further comprising refining the search result by receiving additional search criteria.

26. A system for implementing a product search in response to a subscriber inquiry, the system comprising:
a memory for storing at least one database, the database including product-specific information for a plurality of products; and
at least one processor in communication with the memory and the subscriber, the at least one processor configured to:
receive a search request from the subscriber, the search request corresponding to a desired product and defined by a plurality of search parameters, each search parameter defined by at least one output unit;
query a data repository using said plurality of search parameters;
receive a search result from said data repository, the search result identifying at least one product, the product defined by a plurality of attributes;
convert at least one of the plurality of attributes to conform with at least one of the plurality of desired output units; and
provide an output of the search result with at least one converted attribute.

27. The system of claim 26, further comprising a random access memory device for storing further instructions for implementing the search.

28. The system of claim 26, wherein the memory is an electronic storage device.

29. The system of claim 26, wherein the memory is a magnetic storage device.

30. The system of claim 26, wherein the processor and the memory define an integrated device.

31. The system of claim 26, wherein the processor is further configured to rank the search result in an ascending order of results matching the search parameters.

32. The system of claim 26, wherein the processor is further configured to refine the search result in response to a secondary search request from the subscriber.

33. The system of claim 26, where the processor is further configured to refine the search results in response to a secondary search request after the subscriber has considered the search results.

34. The system of claim 26, further comprising means for a subscriber to access the system.
